(19) United States
(12) Patent Application Publication
(10) Pub. No.: US 2023/0298455 A1
(43) Pub. Date: Sep. 21, 2023

(54) MONITORING, TRACKING, VERIFICATION, AND ALERT SYSTEM

(71) Applicant: Scott Willis, Mt. Pleasant, SC (US)

(72) Inventor: Scott Willis, Mt. Pleasant, SC (US)

(21) Appl. No.: 18/124,081

(22) Filed: Mar. 21, 2023

Related U.S. Application Data
(60) Provisional application No. 63/321,850, filed on Mar. 21, 2022.

(51) Int. Cl. G08B 21/22; H04W 4/021; G06F 21/32

(52) U.S. Cl. CPC G08B 21/22; H04W 4/021; G06F 21/32

(57) ABSTRACT

A method and system of tracking a monitored individual include a device to track the location of the monitored individual, a verification device to confirm the identity of the monitored individual, status information for the monitored individual that is transmitted to a receiver and an associated computing device, a database for holding the status information, and a transmitter to alert a defined designated receiver in the event the monitored individual is in a prohibited geographic region or near another monitored individual. The method and system can access other systems to verify the status information received for the monitored individual. Associated information and graphical access systems allow the designated receiver to track the location of the monitored individual over time, and the system iteratively learns attributes of the monitored individual to issue a faster subsequent alert when status information has exceeded desired parameters.

### CROSS REFERENCE TO RELATED APPLICATIONS

This utility patent application claims benefit of U.S. Provisional Patent Application Ser. No. 63/321,850 filed in the United States Patent and Trademark Office on Mar. 21, 2022, which is incorporated in its entirety by reference thereto.

### BACKGROUND OF THE DISCLOSURE

For decades numerous attempts have been made to solve the problem of restricting movement of parolees, particularly to prevent their travel into sensitive, vulnerable, or prohibited areas.

There have been few successes with body apparatuses, such as ankle bracelets, to ensure that movements of monitored persons are confined to limited geographic areas, such as a monitored person's home or neighborhood, or to prevent that person's proximity to prohibited addresses or entry into areas under a restraining order. However, a shortcoming of existing systems is a limited capacity to alert law enforcement in a timely fashion to intercept and halt the monitored person's movement before that person enters a prohibited area. Another problem with existing systems is an inability to confirm whether data being received from a monitored device being worn by the monitored person is accurate and legitimately associated with that person.

Another need in the industry is for a monitoring system that can provide a history of movement and locations of a monitored person. Such a tracking history could be used by law enforcement to confirm whether the monitored person was in an area when a separately reported incident occurred in the affected area. A historical tracking system could also be used to assess whether boundary violations or new incidents require reincarceration of the monitored person and could be useful to parole officers, for example, when the officers communicate with monitored persons concerning parole status.

Without an effective monitoring system, it is unlikely that law enforcement has the resources to effectively contain accused or convicted individuals from movement beyond an area or to prevent a person's entry into a restricted area in real time or accurately assess whether violations have occurred. A monitoring system populated with accurate, immediate information could be useful in detaining a monitored individual during a violation and/or in determining whether a repeat offender can be subjected to further limitations or penalties imposed by a law enforcement agency, magistrates, or courts.

Monitoring systems have been developed using, for example, fuzzy logic in determining when to record information concerning a person that is being tracked. However, such systems are subject to a failure to record when the fuzzy logic rules are not met. Monitored individuals also have the resources to learn how to avoid triggering such systems. Therefore, continuous monitoring of individuals is more effective and preferred in order to continue to accurately track those individuals and prevent their movement beyond an area to which they have been limited or to prevent them from entering an area where entry is prohibited.

A needed monitoring system must also be designed to protect privacy when such personal information is being transmitted across a public network, such as through a mobile phone or a computer network linked to receive such information wirelessly or via a cellular network. The failure to prevent the public availability of such information has the potential of placing the monitored individual in harm's way if an unfavorable person gains access to the information.

Additionally, while a monitored person can be ordered to carry a phone that is capable of transmitting information to a monitoring system, contact may be lost with the monitored individual due to loss of battery power, a poor signal in an area where the monitored individual is located, or a broken phone. It is preferable to directly track a device or devices that are used for such tracking to avoid the problems associated with mobile phone transmission of information.

Thus, a need remains in the industry to enable reliable monitoring and accurate transmission of information relative to a person subject to monitoring. A further need includes continuous monitoring of the individual with a real-time capability to assess when law enforcement personnel or other authorities should be immediately alerted to a violation by the monitored individual. Still further, a need includes continuous monitoring to permit authorized persons to access historical information regarding the monitored individual to determine whether appropriate or alternative actions should be taken for that monitored individual.

### SUMMARY OF THE DISCLOSURE

The present disclosure provides systems and methods for tracking and/or locating a person who is subject to requisite monitoring by a family, a company, a law enforcement agency, a court, and the like. The reliable convict tracking and restriction solutions described herein can ensure the safety of the general public, decrease jail and prison populations, reduce incarceration costs, and contribute to more effective and efficient rehabilitation of convicts and their rapid reintegration into society as productive citizens by providing a parolee data management architecture that causes a more efficient, real-time use of network and system resources.

Systems according to the disclosure—in subsequent, smarter versions that learn and develop and expand their data set or library based on authorized user feedback and tracked data—are able to suggest errors, violations, and/or perceived or anticipated violations by certain individuals in subsequent iterations. For instance, in a first iteration, an authorized user may input: “Track parolee Smith until he crosses the state line.” Here, Smith is the subject, “track” is the step, and “crosses the state line” is the condition that triggers the next action—a warning message to Smith or a call to the police, for instance. Initially, the system may need to query the user, “What do you mean by track?” or “How long do you want me to track Smith if he still has not crossed the state line?” The next time, after the user informs the system, e.g., “for 8 hours or until Smith checks in,” the system will know context and meaning. Furthermore, the system can recognize other monitored persons that may benefit from “tracking until check in” and begin making appropriate suggestions in other similar cases. Moreover, once the system interprets the difference between tracking and waiting for a check in, for example, it will iteratively understand that it may need to send a query to the authorized user between these conditions, if applicable to a particular parolee or monitored individual.

The present disclosure provides, for instance, a system for tracking and/or locating a monitored individual by family, a company, a law enforcement agency, a court, and the like. In certain embodiments of the disclosure, the monitoring system relies upon access to not only one or more monitoring devices carried by or located on the person being monitored but accesses a third party system to confirm the results received by the monitoring system.

In particular embodiments of the disclosure, the system is capable of alerting third parties when the person being monitored leaves a geographic area in which he or she is required to remain and/or enters a geographic area that he or she is prohibited from entering. In certain embodiments of the disclosure, the system is capable of identifying when the person being monitored is in close proximity to another monitored individual. In other embodiments of the disclosure, the system records information about the monitored individual and allows an authorized user access to the recorded historical information.

A further aspect of the disclosure provides a method for monitoring a monitored individual through at least one tracking device. The tracking device can determine a location of the monitored individual, and also confirm that the monitored individual is a desired person to be monitored using a verification device. The method additionally includes the step of sending status information about the monitored individual from the tracking device to a monitoring system.

The exemplary method may also include steps for tracking the status information against a profile for the monitored individual to determine whether the monitored individual is in a defined allowed geographic region, a defined prohibited geographic region, and/or within a defined proximity relative to another monitored individual. The method then alerts a designated receiver if the monitored individual is within, near, or outside of one of those areas or regions.

In certain embodiments of the disclosure, the verification step includes a verification device that has at least one of an application-based (“app-based”) identification system and a text-based identification system located on the tracking device. In other embodiments of the disclosure, the verification step includes a verification device having an app-based identification system and a biometric authenticator located on the tracking device. Non-limiting exemplary biometric authenticators used may be any one of facial recognition, fingerprint recognition, thumb print recognition, eye vein recognition, finger vein recognition, hand geometry recognition, iris recognition, body odor recognition, palm print recognition, palm vein recognition, retinal scan recognition, skin reflection recognition, thermography recognition, keystroke dynamic recognition, signature recognition, speaker recognition, voice recognition, lip motion recognition, and any combination thereof.

In still other embodiments of the disclosure, the verification step includes a verification device includes the tracking device that is secured to the monitored individual. Examples of these kind of tracking devices include, but no limited to, an ankle bracelet, wrist bracelet, and any type of implant.

In another embodiment of the disclosure, the accessing status information for the monitored individual from another system. Further pursuant to this embodiment of the disclosure, the method may include the step of comparing the status information received from the at least one tracking device to the status information received from the other system to determine the authenticity of the status information.

In still other embodiments of the disclosure, the method additional includes the step of storing the status information in a database. Further pursuant to this embodiment of the disclosure, the method may further include the step of allowing the designated receiver to track a travel path of the monitored individual over a period of time through an interface to the monitoring system.

Another aspect of the disclosure provides a system for monitoring a monitored individual comprising at least one tracking device. According to this embodiment of the disclosure, the tracking device is operable to determine a location of the monitored individual.

The system additionally comprises a verification device used to determine whether the monitored individual is a desired person to be monitored. Components associated with the system, according to other embodiments of the disclosure, include a receiver configured to receive status information transmitted by the at least one tracking device; a database for holding the status information received for the monitored individual; and at least one computing device to track the status information against a profile for the monitored individual to determine whether the monitored individual is in at least one of a defined allowed geographic region, a defined prohibited geographic region, and within a defined proximity relative to another monitored individual. Further pursuant to the latter component, the system may additionally comprise a transmitter to alert a designated receiver if the monitored individual is at least one of not in the defined allowed geographic region, in the defined prohibited geographic region and within a defined proximity relative to another monitored individual.

In certain embodiments of the disclosure, the verification device has at least one of an app-based identification system and a text-based identification system located on the tracking device. In other embodiments of the disclosure, the verification device has an app-based identification system and a biometric authenticator located on the tracking device. Further pursuant to this embodiment of the disclosure, the biometric authenticator may be selected from facial recognition, fingerprint recognition, thumb print recognition, eye vein recognition, finger vein recognition, hand geometry recognition, iris recognition, body odor recognition, palm print recognition, palm vein recognition, retinal scan recognition, skin reflection recognition, thermography recognition, keystroke dynamic recognition, signature recognition, speaker recognition, voice recognition, lip motion recognition, and any combination thereof.

In yet other embodiments of the disclosure, the verification device includes the tracking device that is secured to the monitored individual. Further pursuant to this embodiment of the disclosure, the verification device may be selected from any one or more of an ankle bracelet, wrist bracelet, and any type of implant.

According to another embodiment of the disclosure, the system for monitoring a monitored individual may additionally comprise a procedure to access status information for the monitored individual from another system. Further pursuant to this embodiment of the disclosure, the procedure compares the status information received from the at least one tracking device to the status information received from the other system to determine the authenticity of the status information.

In certain embodiments of the disclosure, the system for monitoring a monitored individual additionally includes an interface to allow the designated receiver to track a travel path of the monitored individual over a period of time. In other embodiments of the disclosure, the at least one tracking device includes a real-time Global Positioning System (GPS) tracker. Further pursuant to this embodiment of the disclosure, the at least one tracking device includes a motion sensor to trigger the real-time GPS tracker.

In yet another aspect, the disclosure provides a system for monitoring a monitored individual includes at least one tracking device for monitoring a location of the monitored individual; a verification device for confirming the monitored individual is a desired person to be monitored; a receiver for sending status information from the at least one tracking device for the monitored individual to a monitoring system; a computing system for tracking the status information against a profile for the monitored individual to determine whether the monitored individual is in at least one of a defined allowed geographic region, a defined prohibited geographic region and within a defined proximity relative to another monitored individual; and a transmitter for alerting a designated receiver if the monitored individual is at least one of not in the defined allowed geographic region, in the defined prohibited geographic region, and within a defined proximity relative to another monitored individual.

In still another aspect of the disclosure, a system is provided for monitoring a monitored individual that includes at least one tracking device for monitoring a location of the monitored individual; a verification device for confirming the monitored individual is a desired person to be monitored; a receiver for sending status information from the at least one tracking device for the monitored individual to a monitoring system; a computing system for tracking the status information against a profile for the monitored individual to determine whether the monitored individual is in compliance with a condition configured for the monitored individual; and a transmitter for alerting a designated receiver if the monitored individual is not in compliance with the condition.

In an embodiment of the disclosure, the condition imposed on the monitor individual may include any one or any combination of reporting to a probation or parole officer; participating in an intensive supervision program; remain in a designated geographic area; report for and maintain regular employment; refrain from changing residence without permission; refrain from changing employment without permission; cease the use of drugs or alcohol; refrain from entering a drinking establishment; refrain from associating with other persons having criminal records who themselves may be subject to the system for monitoring; refrain from possessing firearms; and obey other laws.

An aspect of the disclosure provides a system for monitoring a monitored individual. The system of the disclosure comprises at least one tracking device, wherein, in an embodiment of the disclosure, the tracking device is operable to determine a location of the monitored individual. The system of the disclosure also comprises a verification device used to determine the monitored individual is a desired person to be monitored, a receiver configured to receive status information transmitted by the at least one tracking device, a database for holding the status information received for the monitored individual, at least one computing device to track the status information against a profile for the monitored individual to determine whether the monitored individual is in at least one of a defined allowed geographic region and a defined prohibited geographic region; and a transmitter to alert a designated receiver if the monitored individual is at least one of not in the defined allowed geographic region and in the defined prohibited geographic region.

In certain embodiments of the disclosure, the verification device includes at least one of an app-based identification system and a text-based identification system located on the tracking device.

In other embodiments of the disclosure, the verification device includes an app-based identification system and a biometric authenticator located on the tracking device. Further pursuant to this embodiment of the disclosure, the biometric authenticator is selected from the group consisting of facial recognition, fingerprint recognition, thumb print recognition, eye vein recognition, finger vein recognition, hand geometry recognition, iris recognition, body odor recognition, palm print recognition, palm vein recognition, retinal scan recognition, skin reflection recognition, thermography recognition, keystroke dynamic recognition, signature recognition, speaker recognition, voice recognition, lip motion recognition, and any combination thereof.

In still other embodiments of the disclosure, the verification device includes the tracking device that is secured to the monitored individual. Further pursuant to this embodiment of the disclosure, the at least one tracking device includes a real-time GPS tracker. Still further pursuant to this embodiment of the disclosure, the at least one tracking device includes a motion sensor to trigger the real-time GPS tracker.

In some embodiments of the disclosure, the verification device comprises a radio-frequency monitor. The radio-frequency monitor is configured to transmit a periodic signal to a to the monitoring system to track the monitored individual. In certain embodiments of the disclosure, the tracking device that is secured to the monitored individual may be an ankle bracelet, a wrist bracelet, and any type of implant for monitoring.

In an embodiment of the disclosure, the system comprises a procedure to access status information for the monitored individual from another system. Further pursuant to this embodiment of the disclosure, the procedure compares the status information received from a tracking device to the status information received from the other system to determine the authenticity of the status information.

Another aspect of the disclosure provides a method having steps that include monitoring a monitored individual with at least one tracking device. Further pursuant to an embodiment of the disclosure, the tracking device is operable to determine a location of the monitored individual.

The method may additionally comprise the steps of confirming the monitored individual is a desired person to be monitored using a verification device, sending status information from the at least one tracking device for the monitored individual to a monitoring system, tracking status information against a profile for the monitored individual to determine whether the monitored individual is in at least one of a defined allowed geographic region and a defined prohibited geographic region, and alerting a designated receiver if the monitored individual is at least one of not in the defined allowed geographic region, in the defined prohibited geographic region, and within a defined proximity relative to another monitored individual.

In another embodiment of the disclosure, the verification device of the confirming step may have at least one of an app-based identification system and a text-based identification system located on the tracking device. In another embodiment of the disclosure, the verification device of the confirming step may have an app-based identification system and a biometric authenticator located on the tracking device. Further pursuant to this embodiment of the disclosure, the biometric authenticator may be selected from the group consisting of facial recognition, fingerprint recognition, thumb print recognition, eye vein recognition, finger vein recognition, hand geometry recognition, iris recognition, body odor recognition, palm print recognition, palm vein recognition, retinal scan recognition, skin reflection recognition, thermography recognition, keystroke dynamic recognition, signature recognition, speaker recognition, voice recognition, lip motion recognition, and any combination thereof. In yet another embodiment of the disclosure, the verification device of the confirming step may include the tracking device that is secured to the monitored individual.

In certain embodiments of the disclosure, the method additionally comprises the step of accessing status information for the monitored individual from another system. Further pursuant to this embodiment of the disclosure, the method comprises the step of comparing the status information received from the at least one tracking device to the status information received from the other system to determine the authenticity of the status information.

The method may additionally comprise the step of storing the status information in a database, according to an embodiment of the disclosure. Further pursuant to this embodiment of the disclosure, the designated receiver may track a travel path of the monitored individual over a period of time through an interface to the monitoring system.

Yet another aspect of the disclosure includes a system for monitoring a monitored individual comprising at least one tracking device for monitoring a location of the monitored individual; a verification device for confirming the monitored individual is a desired person to be monitored; a receiver for sending status information from the at least one tracking device for the monitored individual to a monitoring system; a computing system for tracking the status information against a profile for the monitored individual to determine whether the monitored individual is in at least one of a defined allowed geographic region, a defined prohibited geographic region and within a defined proximity relative to another monitored individual; and a transmitter for alerting a designated receiver if the monitored individual is at least one of not in the defined allowed geographic region, in the defined prohibited geographic region, and within a defined proximity relative to another monitored individual. The system may further include an interface to allow the designated receiver to track a travel path of the monitored individual over a period of time.

Additional objects and advantages of the present subject matter are set forth in, or will be apparent to, those of ordinary skill in the art from the description herein. Also, it should be further appreciated that modifications and variations to the specifically illustrated, referenced, and discussed features, processes, and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of the various embodiments, and others, upon review of the remainder of the specification.

### BRIEF DESCRIPTION OF THE DRAWINGS

A full and enabling disclosure of the present subject matter, including the best mode thereof directed to one of ordinary skill in the art, is set forth in the specification, which refers to the appended figures, wherein:

FIG. 1 is a diagrammatic view of a personal tracking system according to an embodiment of the disclosure;

FIG. 2 is a diagrammatic view of a personal tracking system according to another embodiment of the disclosure;

FIG. 3 is a diagrammatic view of a personal tracking system according to yet another embodiment of the disclosure;

FIG. 4 is a flowchart with exemplary screenshot showing an individual check-in procedure according to an aspect of the disclosure; and

FIG. 5 is a flowchart showing a roll-call of a group of monitored individuals with respective exemplary screenshots according to an aspect of the disclosure.

### DETAILED DESCRIPTION OF THE DISCLOSURE

As required, detailed embodiments are disclosed herein; however, the disclosed embodiments are merely exemplary and may be embodied in various forms. Therefore, specific structural and functional details disclosed herein are not to be interpreted as limiting, but merely as a basis for the claims and as a representative basis for teaching one skilled in the art to variously employ the exemplary embodiments of the present disclosure, as well as their equivalents.

Unless defined otherwise, all technical and scientific terms used herein have the same meaning as is commonly understood by one of ordinary skill in the art to which this disclosure belongs. In the event that there is a plurality of definitions for a term or acronym herein, those in this section prevail unless stated otherwise.

Internet Capable Device means including but not limited to portable, non-portable, wearable, non-wearable, embedded, non-embedded, automated, human controlled devices, or software and combinations thereof, capable of using a proxy.

“User,” “Computing Device,” or “User Device” means any portable, non-portable, wearable, non-wearable, embedded, non-embedded, automated, human controlled device, or software that can access the Internet.

“Latency” (or Lag) is a time delay between a cause and an effect of some physical change in the system being observed, but as used herein “latency” is a time interval between the input to a stimulation and the visual or auditory response, often occurring because of network delay.

“DC” means a monitoring or data center.

A “monitored person,” “monitored individual,” “end user,” “patient,” “parolee,” “paroled person,” “convict,” or the like means someone who is subject to tracking and reporting requirements.

“Multihoming” means the practice of connecting a host or a computer network to more than one network to increase reliability or performance.

“Packet” is a Formatted Unit of Data.

“Frame” is a container for a single Packet pursuant to an OSI (Open Systems Interconnection) model.

Sub-requests mean subsidiary or “child” requests that build a primary or “parent” request.

The phrase “Artificial Intelligence” (AI) means a synthetic entity that can make decisions, solve problems, and function like a human being by learning from examples and experience, understanding human language, and/or interactions with a human user, i.e., via a chat system. The AI synthetic entity may be equipped with memory and a processor having a neural network, as well as other components, that can iteratively learn via supervised machine learning (ML) (for example, through inputted data) or capable of autonomous, unsupervised deep learning (DL) (for example, based on inputted data or perceived data and trial and error). AI, ML, and DL may be used interchangeably herein.

A neural network means AI having an input level or data entry layer, a processing level (which includes at least one algorithm to receive and interpret data but generally at least two algorithms that process data by assigning significances, biases, et cetera to the data and interact with each other to refine conclusion or results), and an output layer or results level that produces conclusions or results.

As used herein, a personal tracking system is intended to represent the multiple embodiments of the disclosure as described herein for the purposes of identifying and monitoring the location of a person. The personal tracking system has multiple useful purposes. According to one embodiment of the disclosure, the personal tacking system will be used to track the location of person accused of a crime, but has been released by meeting bail. Such a system can ensure such a person remains available to appear for a hearing to determine whether they are guilty or not. In another embodiment of the disclosure, the personal tracking system may be used in lieu of incarnation in a jail or prison to ensure the guilty person remains in a restricted area. In another embodiment of the disclosure, the personal tracking system may be used in lieu of an in-person “check-in” with a parole officer, probation officer, bail bonding agent, etc. or to respond to a check-in request by such a parole officer, probation officer, bail bonding agent, etc. In other embodiments of the disclosure, the person may be subject to a restraining order and restricted from entering a specified area including an area in proximity to another person, whereby the other person may also be monitored using the system to ensure the person subject to the restraining order maintains a suitable distance from the other person. Many uses of the personal tracking system, as further detailed herein, may be contemplated. All such uses are intended to be covered by this disclosure.

Probation is a court-ordered period of supervision in the community that is generally used as an alternative to jail or prison. While not all released felons are put on parole, a large majority of those released are subjected to some form of community supervision. The Bureaus of Justice Statistics estimate that about 4.8 million people are on probation or parole in the United States.

The conditions a released individual must comply with for probation or parole are court-ordered and may vary depending upon the past crime or crimes of the individual and the extent of past reliability that individual has exhibited in post-release programs. For example, a non-extensive list of the rules that may be imposed by the court may include reporting to probation or parole officers; participating in intensive supervisions programs; not leaving a designated geographic area without permission; finding, reporting for and maintaining regular employment; not changing residence or employment without permission; not using drugs or alcohol and not entering drinking establishments; not associating with other persons having criminal records who themselves may be subject to a program of post-release supervision; as well as many other conditions potentially involving firearms, obeying government laws, as well as a host of other conditions that could well be subject to monitoring through the system identified in the disclosure.

Indeed, the personal tracking system of the disclosure is capable of being configured to electronically monitor the individual subject to any of the aforementioned conditions in an electronic and continuous manner, and report any such violations of these conditions to appropriate personnel. Further, the different levels and extent of verification of the identity of the individual being subjected to monitoring may be specifically configured based upon review by the court and the affiliated probation or parole office to determine the extent of security required for the person being subjected to monitoring. The personal tracking system will also reduce—if not eliminate altogether—the need for personal checks with probate or parole officers, bail bondsmen and the like.

In one aspect, one or more conditions associated with the tracking information received for the individual being subjected to monitoring may be configured for that individual. Further pursuant to this embodiment of the disclosure, the appropriate law enforcement personnel defined for the monitored individual may be notified when the monitored individual has failed to comply with such a condition.

When it is discovered that a monitored individual is not in compliance with the conditions imposed on that individual who is subject to release, such violations can be immediately reported or reported in due course to, depending upon how the personal tracking system is configured for that individual, to the identified law enforcement personnel and/or probation or parole officer assigned to that individual. Additionally, such information is historically stored and may be accessed upon, for example, a showing that the conditions imposed on the individual must be further restricted or that individual is no longer subject to post-release and subjected to incarceration.

Other situations arise when an individual being subjected to monitoring enters a geographic region that the individual has otherwise been ordered to remain away from. For example, such geographic regions may be fixed by the court or may vary depending upon the location of another individual that can be subjected to monitoring using the personal tracking system of the individual. Similarly, such impermissible entries in such a geographic region may be reported to the appropriate law enforcement personnel and acted upon accordingly.

Arrest and availability of an individual subject to release for trial is also an important aspect of the criminal justice system. While the current justice system primarily relies upon the imposition of bail in an attempt to ensure the individual returns for trial, there are those circumstances that arise when the person chooses not to return for trial. The personal tracking system of the disclosure may monitor the individuals that are situated in this position, and guide law enforcement to where that are located when they fail to appear.

Wherever the phrases “for example,” “such as,” “including,” and the like are used herein, the phrase “and without limitation” is understood to follow unless explicitly stated otherwise. Similarly, “an example,” “exemplary,” and the like are understood to be non-limiting.

The term “substantially” allows for deviations from the descriptor that do not negatively impact the intended purpose. Descriptive terms are understood to be modified by the term “substantially” even if the word “substantially” is not explicitly recited.

The term “about” when used in connection with a numerical value refers to the actual given value, and to the approximation to such given value that would reasonably be inferred by one of ordinary skill in the art, including approximations due to the experimental and or measurement conditions for such given value.

Unless the context clearly requires otherwise, throughout the description and the claims, the words “comprise”, “comprising”, and the like are to be construed in an inclusive sense as opposed to an exclusive or exhaustive sense; in the sense of “including, but not limited to.”

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, et cetera. Thus, for example, “a device having components a, b, and c” means that the device includes at least components a, b, and c. Similarly, the phrase: “a method involving steps a, b, and c” means that the method includes at least steps a, b, and c.

Where a list of alternative component terms is used, e.g., “a structure such as ‘a’, ‘c’, ‘d’ or the like”, or “a” or b″, such lists and alternative terms provide meaning and context for the sake of illustration, unless indicated otherwise. Also, relative terms such as “first,” “second,” “third,” “front,” and “rear” are intended to identify or distinguish one component or feature from another similar component or feature, unless indicated otherwise herein.

The various embodiments of the disclosure and/or equivalents falling within the scope of the present disclosure overcome or ameliorate at least one of the disadvantages of the prior art.

Detailed reference will now be made to the drawings in which examples embodying the present subject matter are shown. The detailed description uses numerical and letter designations to refer to features of the drawings. The drawings and detailed description provide a full and written description of the present subject matter, and of the manner and process of making and using various exemplary embodiments, so as to enable one skilled in the pertinent art to make and use them, as well as the best mode of carrying out the exemplary embodiments. The drawings are not necessarily to scale, and some features may be exaggerated to show details of particular components. Thus, the examples set forth in the drawings and detailed descriptions are provided by way of explanation only and are not meant as limitations of the disclosure. The present subject matter thus includes any modifications and variations of the following examples as come within the scope of the appended claims and their equivalents.

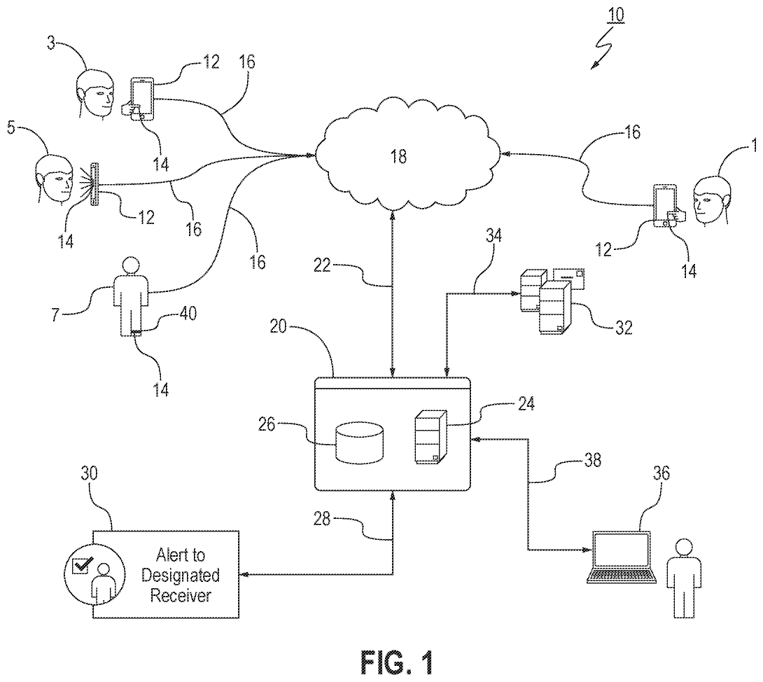

Turning now to the figures, according to an embodiment of the disclosure a diagrammatic view of a personal tracking system, which is broadly designated by element number 10, is shown in FIG. 1. The system 10 may include a verification device 14 that further includes at least one of an app-based identification system and a text-based identification system located on a tracking device 12 for monitoring a user 1, also referred to herein as a monitored individual, a parolee, and the like. More particularly. the tracking device 12 is used to determine a location of the monitored individual 1, and the verification device 14 determines whether the monitored individual 1 is the appropriate individual to be monitored. In one aspect the verification device 14 may be integrated with the tracking device 12. In other embodiments of the disclosure, the verification device 14 may be independent of the tracking device 12. In still other embodiments of the disclosure the verification device 14 includes a component that is independent of the tracking device 12 and includes a data transmission interconnect (e.g., a wireless connection) with the tracking device 14. Here, attribute data for the monitored individual 1 may be generated by a machine-learned identification system comprised, for example, of a hub 20 and an independent system 32, which may be located in a geographic area remote from the hub 20 to prevent spoofing or compromise and to provide redundancy and/or additional computing capacity. More particularly, the hub 20 and the system 32 operate together to receive monitored personal data for numerous monitored persons spread over a wide geographic area, assign learned and weighted significance to each person or group, and assign biases, confidence levels and the like to the received data to produce conclusions and results with increasing degrees of confidence as the machine-learning system 10 receives and learns from each data input.

Also in the exemplary embodiment in FIG. 1, the verification device 14 can include at least one of an application (app)-based identification system and a text-based identification system located on the tracking device 12. By way of example, the tracking device 12 transmits status information 16 through at least one of a wireless interface, a cellular network, and a cloud configuration 18. The exemplary embodiment of FIG. 1 further illustrates the hub 20, briefly introduced above, which is configured to receive the status information 18 via a transmission interface 22 configured to receive the status information 16 from the wireless interface, cellular network, and/or cloud configuration 18. The hub 20 may include one or more computing devices 24 for processing the status information 16 received from the monitored individual 1. Here, the computing device 24 may be located within the hub 20 and may be any suitable hardware and software configuration now known or eventually conceived of in the art. The hub 20 may further comprise a database 26. In certain embodiments, the database 26 is a data repository for any information that may be needed by the personal tracking system 10 that is associated with the monitored individual 1. Such information may include, but is not limited to, a geographic location where the monitored individual 1 is permitted to be located, or another geographic location where the monitored individual 1 is not permitted to be located, or another monitored individual 3, 5, 7 et cetera. with whom the monitored individual 1 is not permitted to be in the vicinity of, a designated receiver/an alert device 30 such as a government agent, a bail agent, etc. who/that is permitted to receive and/or review information 16 related to the monitored individual 1, and any combination thereof. In one aspect, the database 26 may be configured to store the status information 16 received for the monitored individual 1.

Information concerning the monitored individual 1 may be entered into the personal tracking system 10 by, for example, an information technology technician 30 assigned to the personal tracking system 10, or the system may receive the information automatically via a designated receiver 30 and may be updated when the monitored individual 1 is authorized to move to a new residence or when the designated individual 1 is no longer restricted from entering a certain geographic region, according to these non-limiting examples.

According to another aspect of the disclosure, the designated individual 30 and the monitored individual 1 may arrange for check in appointments and conduct such check in appointments through the personal tracking system 10. In certain embodiments of the disclosure, the check in appointments may be a one-time scheduled event (vis-à-vis a demand for an immediate check-in or a check-in within a period of time or at a certain time), while in other embodiments of the disclosure, the check-in appointments may be regularly scheduled check in appointments.

As further shown in FIG. 1, the personal tracking system 10 may include an alert transmitter 28 that is configured to notify the designated receiver/an alert device 30 when the status information 16 received for the monitored individual 1 is not in conformance with the limitations configured in the personal tracking system 10 for that monitored individual 1. For example, such personal limitations may include not being in a defined allowed geographic region, being in a defined prohibited geographic region, being in a defined proximity to another monitored individual, and any combination thereof.

Also shown in FIG. 1, the other system 32, briefly introduced above, may be provided to collect the status information 16 from the monitored individual 1. More specifically, the other system 32 can collect the status information 16 from the tracking device 12. Additionally or alternatively, the other system 32 collects the status information 16 from the monitored individual 1 using another device configured to collect either the same status information 16 or information that can be converted to the status information 16 as it is otherwise received by the personal tracking system 10. In an embodiment of the disclosure, the personal monitoring system 10 compares the information received from the other system 32 to the status information 16 collected from the monitored individual 1 to ensure that the status information 16 is accurate. For instance, the information from the other system 32 is accessed by the personal monitoring system 10 through an access control link 34 to the other system 32 (e.g., a Mongo Database). The system 32 may house information specific to all users 1, 3, 5, 7, et cetera. By way of exemplary operation, during an initial log in, an end user such as user 1 is tasked with inputting the user's personal telephone number into his phone 12, which will send a request to the hub 20 to verify the user 1. The hub 20 will then reach out to the shared Mongo Database 32 to verify the user 1. The other system 32 will return a unique identifier for the user 1 and the URL to which the user 1 is associated. This information is then returned to the phone 12 and the information is saved. The following Table 1 shows the function that is triggered when the user 1 logs in on his device 12.

```
TABLE 1
  const onLoginButtonPress = async ( ) => {
    console.log(phone);
    const res = await
fetch(‘https://nationalpretrial.azurewebsites.net/api/accusedapi/verifyNPTUser?Phone=${
phone}’, {
      method: ″post″
    })
    console.log(res)
    if (res.ok) {
      const data = await res.json( );
      if(data.success == true)
      {
        setUrl(data.url);
        const res = await
fetch(‘${data.url}/api/accusedapi/getAdditionalInfoFromPhoneNumber?Id=${phone}’, {
          method: ″post″,
          headers: {
            ′Content-Type′: ′application/json′
          }
        })
        console.log(res)
        if (res.ok) {
        const data = await res.json( );
        if(data.success == true)
        {
          console.log(‘full string’, data);
          setTrackingId(data.fullString)
          navigation.replace(′VerificationScreen′)
        }
        else{
          setError(″Login Failed″);
        }
        }
        else{
          setError(″An error occured logging in″);
        }
      }
      else{
      setError(″Login Failed″);
      }
    }
    else{
      setError(″An error occured logging in″);
    }
```

Information from the Check-In-Center 20 is then received according to following settings (AccusedAPIController.cs) in Table 2:

TABLE 2

```
  [HttpPost(″verifyNPTUser″)]
public async Task<IActionResult> VerifyNPTUser(string Phone)
{
  var url = await _accusedHelper.VerifyNPTUser(Phone);
  if(url == null)
  {
    return Ok(new
    {
      success = false
    });
  }
  else
  {
    return Ok(new
    {
      success = true,
      url = url
    });
  }
}
```

The Check-In-Center 20 then searches the database 32 according to the following method shown in Table 3 and returns information to the Check-In-Center app (AccusedAPIController.cs):

```
TABLE 3
  internal async Task<string> VerifyNPTUser(string phone)
  {
    string url = null;
    var user = _mongoCrud.GetActiveRecordByPhone<Users>(″Users″,
phone.GetNumbers( ));
    if (user.Id != null)
      url = user.Url;
    return url;
  }
```

The personal tracking device 10 additionally comprises a graphical user interface (GUI) 36 having an access interface 38 that allows the designated receiver to collect and review information on the monitored individual 1 held by the personal tracking device 10. Without intending to be limiting, such information may include the ability to track a travel path of the monitored individual 1 over a period of time. Also, the GUI 36 may be used to request, schedule and conduct check in appointments with the monitored individual 1. An authorized user may also be permitted to change conditional and any other parameters associated with the monitored individual 1 using the GUI 36.

In certain embodiments of the disclosure, the designated agent that receives information on the alert device 30 or the GUI 36 can be provided with an app-based or some other programmed interface to allow that agent to communicate with the personal tracking device 10 that further allows that agent to not only access information concerning the monitored individual 1 but to request that the monitored individual 1 check in with the agent using either the alert device 30 or the GUI 36, for instance, through the personal monitoring device 10. The agent may also be authorized to program or update geographic parameters or other parameters related to certain conditions imposed on the monitored individual 1 as further discussed herein.

Also illustrated in the exemplary embodiment of FIG. 1, the personal tracing device 10 may monitor a plurality of monitored individuals 3, 5, 7, each having a transmission device 12, a verification device 14, and respective status information 16. Moreover, the individual 7 may be equipped with a wearable device 40 that sends information 16 to the wireless interface, cellular network, and/or cloud configuration 18.

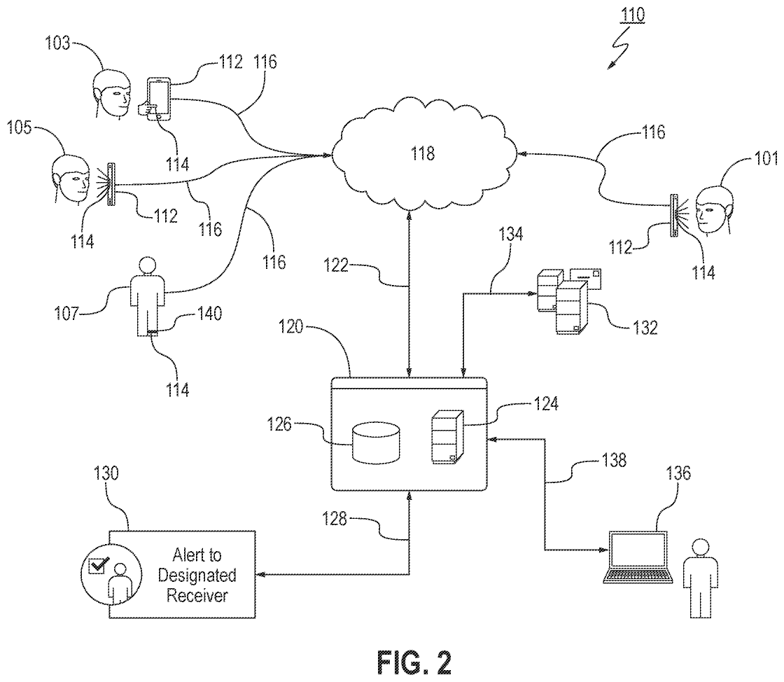

FIG. 2 is a diagrammatic view of a personal tracking system 110 according to another embodiment of the disclosure in which a verification device 114 may include an app-based identification system and a biometric authenticator located on a tracking device 112. More specifically, FIG. 2 shows a monitored individual 101, a tracking device 112, and a verification device 114. The verification device 114 may include an app-based identification system and a biometric authenticator. The biometric authenticator may be selected from facial recognition, fingerprint recognition, thumb print recognition, eye vein recognition, finger vein recognition, hand geometry recognition, iris recognition, body odor recognition, palm print recognition, palm vein recognition, retinal scan recognition, skin reflection recognition, thermography recognition, keystroke dynamic recognition, signature recognition, speaker recognition, voice recognition, lip motion recognition, and any combination thereof.

FIG. 2 also shows that another system 132 may be provided to collect status information 116 from the monitored individual 101 via the tracking device 112 and the verification device 114. More specifically, the other system 1322 can collect the status information 116 from the tracking device 122, or additionally, or alternatively, the other system 132 can collect the status information 116 from the monitored individual 101 using another device configured to collect either the same status information 116 or information that can be converted to the status information 116 as it is otherwise received by the personal tracking system 110.

In one aspect of the disclosure, the personal monitoring system 110 shown in FIG. 2 compares information 134 received from the other system 132 to the status information 116 collected from the monitored individual 101 to ensure that the status information 116 is accurate. For instance, the information 134 from the other system 132 may be accessed by the personal monitoring system 110 through an access control link 134 to the other system 132 (e.g., a Mongo Database). The system 132 may house information specific to all users 101, 103, 105, 107, et cetera. By way of exemplary operation, during an initial log in, an end user such as user 1101 is tasked with inputting the user's personal telephone number into his phone 112, which will send a request to the hub 120 to verify an identity of the user 101. The hub 120 will then reach out to the shared Mongo Database 132 via the access control link 134 to verify the user 101. The other system 132 will return a unique identifier for the user 101 and the URL to which the user 101 is associated. This information is then returned to the phone 112 and the information is saved.

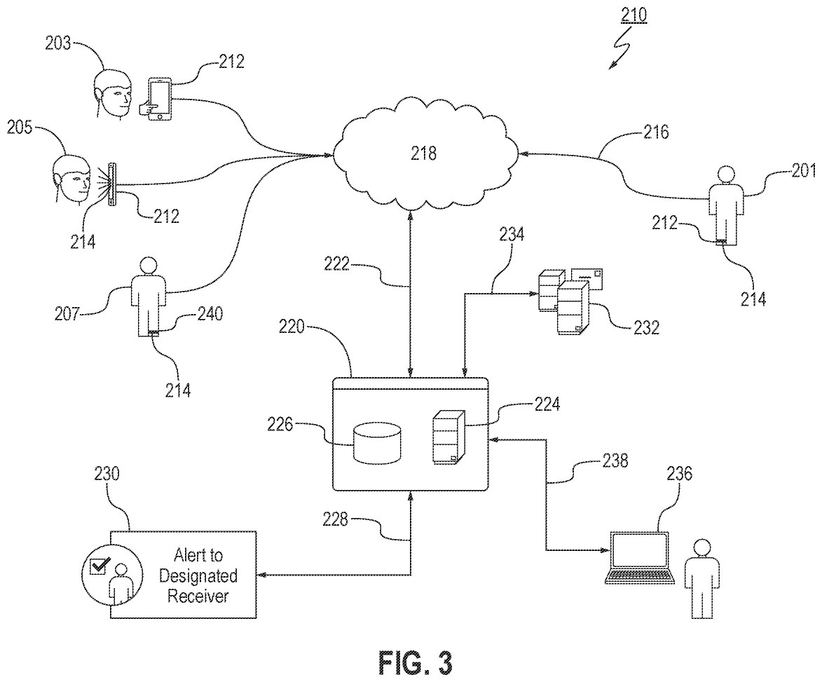

FIG. 3 is a diagrammatic view of a personal tracking system 210 according to another embodiment of the disclosure in which a monitored individual 201 may use a verification device 214 that includes a tracking device 212. Other monitored individuals 203, 205, and 207 may use a variety of verification devices 214 including devices 240 that are affixed to the user 207. As shown, the tracking device 212 and the verification device 240 may be separate devices.

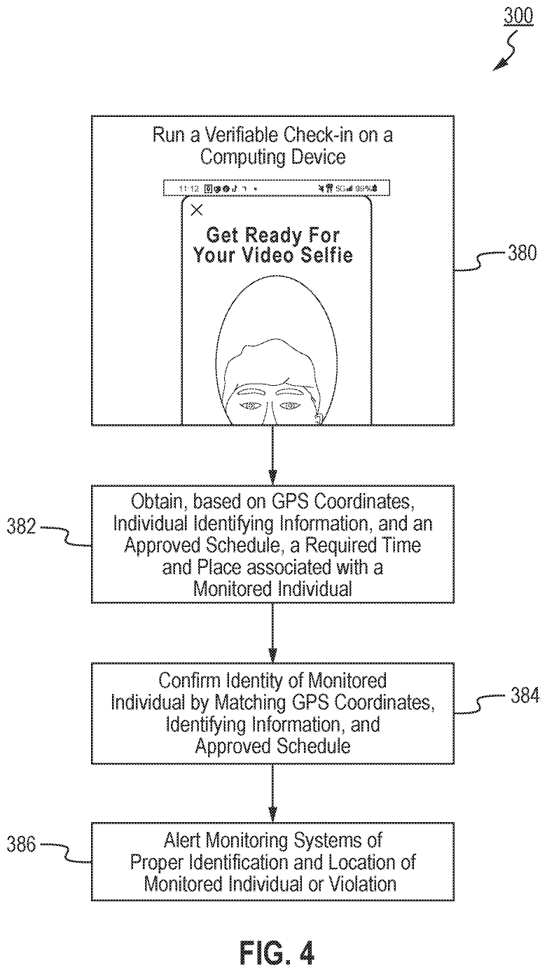

FIG. 4 is a flowchart of an exemplary method involving the present embodiments. As shown in FIG. 4, the method 300 may include running a verifiable check-in on a computing device from an authentication platform such as a Check-In-Center at step 380, obtaining individual identifying information for a monitored individual, an approved schedule, and a required or compulsory time and place based on GPS coordinates at step 382, confirming the identity of the monitored individual by matching the GPS coordinates, identifying information, and the approved schedule to a database at step 384, and alerting monitoring systems of proper identification and location of the monitored individual or of a violation by that individual at step 386.

More specifically, at step 380 in FIG. 4, the check-in may be accomplished using a FaceTec® Authentication Screen for the Check-In-Center to conduct its authentication. For example, an end user, such as a monitored person 1 introduced above, has entered proper permissions and launches FaceTec's Facial Recognition Authentication application. If recognition is successful, the person's information is delivered to the Check-In-Center, for instance, using cellular or satellite data. The following Table 4 shows an example of the Check-In-Center's corresponding settings within its computing device to accomplish step 382 of FIG. 4:

```
TABLE 4
const handleFaceCheckin =async ( ) => {
  setVisible(false)
  setIsLoading(true)
  if(user.TrackingLevel != ″1″){
        let camera;
if(Platform.OS == ″android″){
          camera = await
PermissionsAndroid.check(PermissionsAndroid.PERMISSIONS.CAMERA);
          if(camera){
            await Facetec.Authenticate(
              ″auth″,
              String(user.TrackingGuid),
              async( ) => handleBasicCheckin( ),
              async e => failure(e)
            )
          }
          else{
            const granted = await PermissionsAndroid.request(
              PermissionsAndroid.PERMISSIONS.CAMERA
            );
            if(granted === PermissionsAndroid.RESULTS.GRANTED){
              await Facetec.Authenticate(
                ″auth″,
                String(user.TrackingGuid),
                async( ) => handleBasicCheckin( ),
                async e => failure(e)
              )
            }
            else{
              setIsLoading(false)
              setModalVisible(true)
            }
          }
        }
        else if(Platform.OS == ″ios″)
        {
          camera = await check(PERMISSIONS.IOS.CAMERA) ===
RESULTS.GRANTED;
          if(camera){
            await Facetec.Authenticate(
              ″auth″,
              String(user.TrackingGuid),
              async( ) => handleBasicCheckin( ),
              async e => failure(e)
            )
          }
          else{
            const granted = await request(
              PERMISSIONS.IOS.CAMERA,
              {
                title: ′Checkin Center Needs Camera Access′,
                message: ′Checkin Center needs access to your camera for
checkins′,
              },
            );
            if(granted === RESULTS.GRANTED){
              await Facetec.Authenticate(
                ″auth″,
                String(user.TrackingGuid),
                async( ) => handleBasicCheckin( ),
                async e => failure(e)
              )
            }
            else{
              setIsLoading(false)
              setModalVisible(true)
            }
          }
        }
      }
      else{
        handleBasicCheckin( );
        success(″Thanks for checking in″);
      }
    }
```

After a successful facial recognition check, the end user's coordinates are sent to the authentication platform. The settings shown in the following Table 5 then enable the application user's user information and coordinates to be obtained by the authentication platform.

```
TABLE 5
const handleBasicCheckin = async( ) => {
    setVisible(false)
    setIsLoading(true)
    var noPhoto = false;
    if(user.TrackingLevel == ″1″)
    {
      noPhoto = true;
    }
    //BackgroundGeolocation.ready(Config).then((state) => {
      BackgroundGeolocation.getCurrentPosition(
      {
        samples: 1,
        persist: false
      },
      async (location) => {
        try {
          var date = new Date( );
          console.log(‘checkin location ${date}’);
          console.log(‘coords : ${location.coords.latitude},
${location.coords.longitude}’)
          const res = await fetch(‘${user.Url}/api/accusedapi/checkin’, {
            method: ″post″,
            headers: {
              ′Content-Type′: ′application/json′
            },
            body: JSON stringify(
              {
                accusedTrackingId: user.TrackingId,
                latitude: location.coords.latitude,
                longitude: location.coords.longitude,
                noPhoto : noPhoto
              }
            )
          })
          console.log(‘Res status: ${res.status}’)
          const data = await res.json( );
          onCheckInSuccess(data);
        } catch (err) {
          setIsLoading(false)
          setVisible(true)
          //setIsVisible(true)
          console.error(err)
        }
      }, async (error) => {
      try {
        const res = await fetch(‘${user.Url}/api/accusedapi/checkin’, {
          method: ″post″,
          headers: {
            ′Content-Type′: ′application/json′
          },
          body: JSON.stringify(
            {
              accusedTrackingId: user.TrackingId,
              latitude: null,
              longitude: null,
              noPhoto : noPhoto
            }
          )
        })
        console.log(error.code, error message);
        console.log(‘Res status: ${res.status}’)
      } catch (err) {
        setIsLoading(false)
        setVisible(true)
        setIsVisible(true)
        console.error(err)
      }
      });
      //BackgroundGeolocation.start( );
    //});
    setIsLoading(false)
    setVisible(true)
    setIsVisible(true)
    //onCheckInSuccess( )
  }
```

The settings shown in the following Table 6 accomplishes step 384 in FIG. 4 by checking the user's check in against requested check ins and geofences and/or related places of interest.

```
TABLE 6
  if (upcomingCheckIn != null)
  {
    if (upcomingCheckIn.GeofenceId != null)
    {
      var distance =
_geoCalcHelper.GetDistanceInMilesBetweenTwoPoints(upcomingCheckIn.Geofence.Lo
ngitude, upcomingCheckIn.Geofence.Latitude, (double)checkInData.Longitude,
(double)checkInData.Latitude);
      if
(_geoCalcHelper.GetDistanceInMilesBetweenTwoPoints(upcomingCheckIn.Geofence.L
ongitude, upcomingCheckIn.Geofence.Latitude, (double)checkInData.Longitude,
(double)checkInData.Latitude) <= upcomingCheckIn.Geofence.Radius)
      {
        //in here
        var geofence = _context.TrackingGeofences.Include(i =>
i.PlaceOfInterest).FirstOrDefault(x => x.Id == upcomingCheckIn.GeofenceId);
        if(geofence.PlaceOfInterestId != null)
        {
          response.poiId = (int)geofence.PlaceOfInterestId;
          response.poiName = geofence.PlaceOfInterest.Name;
          response.requestNextCheckin =
geofence.PlaceOfInterest.AccusedScheduled;
        }
        type = (int)upcomingCheckIn.CheckInTypeId;
        upcomingId = upcomingCheckIn.Id;
        if (type == 2 || type == 3)
        {
          RemoveNonRecurringUpcomingCheckIns(upcomingCheckIn);
        }
        else if (type == 1)
        {
          await UpdateUpcomingCheckIns(upcomingCheckIn);
        }
        checkInToUpdate = _context.AccusedCheckIns
            .Where(x => x.UpcomingCheckInId ==
upcomingCheckIn.Id && (x.TimeWindowStart <= now && x.TimeWindowEnd >=
now) && x.Completed == false)
            .FirstOrDefault( );
        checkInToUpdate.CheckInTime = now;
        checkInToUpdate.Completed = true;
        checkInToUpdate.LocationId = locationId;
        messageToAdd = new AccusedChat( )
        {
          Message = $″Live Verified Check-In Recorded − DD
{checkInData.Latitude} {checkInData.Longitude} −
{timeToUse.Date.ToShortDateString( )} {timeToUse.DateTime.ToShortTimeString( )}″ +
          $″ For Geofence {upcomingCheckIn.Geofence.Name}″,
          ChatType = ″System Notification″,
          AccusedTrackingId = defendantTracking.Id,
          DateCreated = now,
          FileSize = checkInToUpdate.Id
        };
      }
      else
      {
        type = 4;
        var checkInToAdd = new AccusedCheckIn( );
        checkInToAdd.CheckInTime = now;
        checkInToAdd.Completed = true;
        checkInToAdd.LocationId = locationId;
        checkInToAdd.AccusedTrackingId = checkInData.AccusedTrackingId;
        var checkInId = SaveCheckin(checkInToAdd);
        //_context.AccusedCheckIns.Add(checkInToAdd);
        messageToAdd = new AccusedChat( )
        {
          Message = $″Live Verified Check-In Recorded − DD
{checkInData.Latitude} {checkInData.Longitude} −
{timeToUse.Date.ToShortDateString( )} {timeToUse.DateTime.ToShortTimeString( )}″,
          ChatType = ″System Notification″,
          AccusedTrackingId = defendantTracking.Id,
          DateCreated = now,
          FileSize = checkInId
        };
```

The settings in the following Table 7 accomplishes step 386 in FIG. 4 by sending messages to the end user and check in administrators regarding the status of the check in.

```
TABLE 7
await_pushNotificationService.SendPushNotification(defendantTracking.Fcmtoken,
″You attempted to checkin outside of your geofence, please enter your predefined
checkIn geofence and try again″, ″Attempted Checkin Outside Geofence″);
        }
      }
      else
      {
        type = (int)upcomingCheckIn.CheckInTypeId;
        upcomingId = upcomingCheckIn.Id;
        if (type == 2 || type == 3)
        {
          RemoveNonRecurringUpcomingCheckIns(upcomingCheckIn);
        }
        else if (type == 1)
        {
          await UpdateUpcomingCheckIns(upcomingCheckIn);
        }
        checkInToUpdate = _context.AccusedCheckIns
            .Where(x => x.UpcomingCheckInId ==
upcomingCheckIn.Id && (x.TimeWindowStart <= now && x.TimeWindowEnd >=
now) && x.Completed == false)
            .FirstOrDefault( );
        checkInToUpdate.CheckInTime = now;
        checkInToUpdate.Completed = true;
        checkInToUpdate.LocationId = locationId;
        messageToAdd = new AccusedChat( )
        {
          Message = $″Live Verified Check-In Recorded − DD
{checkInData.Latitude} {checkInData.Longitude} −
{timeToUse.Date.ToShortDateString( )} {timeToUse.DateTime.ToShortTimeString( )}″,
          ChatType = ″System Notification″,
          AccusedTrackingId = defendantTracking.Id,
          DateCreated = now,
          FileSize = checkInToUpdate.Id
        };
      }
      if(checkInToUpdate.AccusedTrackingId != 0)
        _context.Update(checkInToUpdate);
      await CreateCheckIn(upcomingCheckIn);
    }
    else
    {
      type = 4;
      var checkInToAdd = new AccusedCheckIn( );
      checkInToAdd.CheckInTime = now;
      checkInToAdd.Completed = true;
      checkInToAdd.LocationId = locationId;
      checkInToAdd.AccusedTrackingId = checkInData.AccusedTrackingId;
      var checkInId = SaveCheckin(checkInToAdd);
      //_context.AccusedCheckIns.Add(checkInToAdd);
      messageToAdd = new AccusedChat( )
      {
        Message = $″Live Verified Check-In Recorded − DD
{checkInData.Latitude} {checkInData.Longitude} −
{timeToUse.Date.ToShortDateString( )} {timeToUse.DateTime.ToShortTimeString( )}″,
        ChatType = ″System Notification″,
        AccusedTrackingId = defendantTracking.Id,
        DateCreated = now,
        FileSize = checkInId
      };
    }
    _context.AccusedChats.Add(messageToAdd);
    _context.SaveChanges( );
  }
  return response;
```

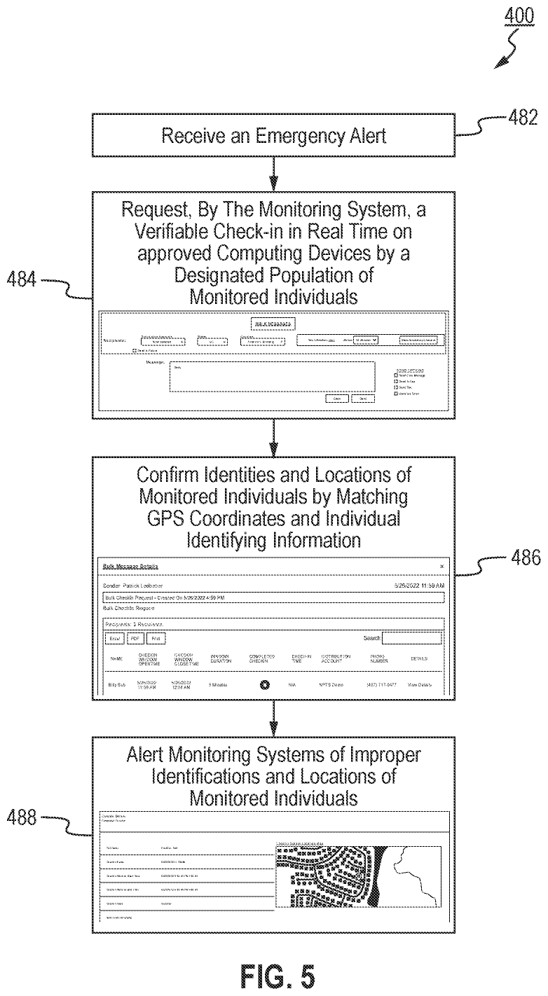

FIG. 5 is a flowchart of another exemplary method involving the present embodiments. As shown in FIG. 5, the method 400 involves receiving an emergency alert at step 482; sending a verifiable check-in request at step 484 from the monitoring system in real time on approved computing devices by a designated population of monitored individuals; confirming identities and locations of monitored individuals by matching GPS coordinates and individual identifying information at step 486; and at step 488 alerting monitoring systems of improper identifications and/or locations of monitored individuals.

More specifically, at step 482 in FIG. 5, an alert is received externally by a third party or independent organization contacting the authentication center. At step 484 mass check ins can requested according to, for instance, Distribution Account, State, County, and Sex Offender. The monitored persons may be given a time limit by which they must respond to the mass check in.

At step 486, all individuals who were required to check in at step 484 can be checked. From here, the details of an individual's check in can be verified by clicking VIEW

DETAILS in the screen shown embedded at step 486 in FIG. 5.

The settings in the following Table 8 accomplishes step 488 in FIG. 5 in which an alert is triggered at the end of each check in request that alerts both the monitored person and the Check-in Center of a missed check in or other violation.

```
TABLE 8
                        [Route(″EndCheckin″)]
  public async Task<IActionResult> EndCheckin(string message) //Mesage is just the
id
  {
    try
    {
      await
_accusedHelper.CheckForMissedCheckinAndSendNotifications(int.Parse(message));
    }
    catch (Exception e)
    {
      return BadRequest(e.InnerException.Message);
    }
    return Ok( );
  }
```

Having described various embodiments of the disclosure, examples may include but are not limited to:

EMBODIMENT 1: A method of monitoring an individual comprising monitoring a monitored individual with at least one tracking device disposed proximate the monitored individual, wherein the tracking device is operable to determine a location of the monitored individual; confirming the monitored individual is a desired person to be monitored using a verification device in electronic communication with the tracking device and in electronic communication with a monitoring system disposed apart from the monitored individual; sending status information regarding the monitored individual from the tracking device to the monitoring system; comparing the status information against a profile for the monitored individual to assess in real-time whether the monitored individual is in at least one of a defined permitted geographic region, a defined prohibited geographic region, or a defined proximity relative to another monitored individual; generating attribute data for the monitored individual; and sending an alert from the monitoring system to a designated receiver if the attribute data does not match the monitored individual or if the monitored individual is not in the defined permitted geographic region, is in the defined prohibited geographic region, or is within the defined proximity relative to another monitored individual.

EMBODIMENT 2: The method of Embodiment 1, wherein the verification device includes an identification system installed in the tracking device.

EMBODIMENT 3: The method of Embodiments 1 or 2, wherein the verification device includes a machine-learned identification system for generating the attribute data generating the attribute data, the attribute data being refined with each check in by the monitored individual.

EMBODIMENT 4: The method of Embodiments 1, 2, or 3, wherein the biometric authenticator is selected from the group consisting of facial recognition, fingerprint recognition, thumb print recognition, eye vein recognition, finger vein recognition, hand geometry recognition, iris recognition, body odor recognition, palm print recognition, palm vein recognition, retinal scan recognition, skin reflection recognition, thermography recognition, keystroke dynamic recognition, signature recognition, speaker recognition, voice recognition, lip motion recognition, and combinations thereof.

EMBODIMENT 5: The method of any of the foregoing embodiments, wherein the verification device includes the tracking device that is secured to the monitored individual.

EMBODIMENT 6: The method of any of the foregoing embodiments, wherein the verification device is an ankle bracelet.

EMBODIMENT 7: The method of any of the foregoing embodiments, further comprising accessing status information for the monitored individual from an independent database on an additional monitoring system.

EMBODIMENT 8: The method of any of the foregoing embodiments, further comprising comparing the status information received from the tracking device to the database of the additional monitoring system to authenticate the status information.

EMBODIMENT 9: The method of Embodiment 1, further comprising storing the status information in a database.

EMBODIMENT 10: The method of any of the foregoing embodiments, wherein the designated receiver may track a travel path of the monitored individual over a period of time through an interface to the monitoring system.

EMBODIMENT 11: A system for monitoring a monitored individual, comprising at least one tracking device, wherein the tracking device is operable to determine a location of the monitored individual; a verification device used to determine the monitored individual is a desired person to be monitored; a receiver configured to receive status information transmitted by the at least one tracking device; a database for holding the status information received for the monitored individual; at least one computing device to track the status information against a profile for the monitored individual to determine whether the monitored individual is in at least one of a defined allowed geographic region, a defined prohibited geographic region, and within a defined proximity relative to another monitored individual; and a transmitter to alert a designated receiver if the monitored individual is at least one of not in the defined allowed geographic region, in the defined prohibited geographic region and within a defined proximity relative to another monitored individual, the computing device iteratively learning attributes of the monitored individual to issue a faster subsequent alert when status information has exceeded desired parameters.

EMBODIMENT 12: The system as in Embodiment 11, wherein the verification device has at least one of an app-based identification system and a text-based identification system located on the tracking device.

EMBODIMENT 13: The system as in Embodiments 11 or 12, wherein the verification device having an app-based identification system and a biometric authenticator located on the tracking device.

EMBODIMENT 14: The system as in Embodiment 13, wherein the biometric authenticator is selected from the group consisting of facial recognition, fingerprint recognition, thumb print recognition, eye vein recognition, finger vein recognition, hand geometry recognition, iris recognition, body odor recognition, palm print recognition, palm vein recognition, retinal scan recognition, skin reflection recognition, thermography recognition, keystroke dynamic recognition, signature recognition, speaker recognition, voice recognition, lip motion recognition, and combinations thereof.

EMBODIMENT 15: The system as in Embodiments 11 through 14, wherein the verification device includes the tracking device that is secured to the monitored individual.

EMBODIMENT 16: The system as in Embodiments 11 through 15, wherein the verification device may be selected from any one or more of an ankle bracelet, wrist bracelet, and any type of implant.

EMBODIMENT 17: The system as in Embodiments 11 through 16, further comprising a procedure to access status information for the monitored individual from a secondary system.

EMBODIMENT 18: The system as in Embodiments 11 through 17, wherein the procedure compares the status information received from the at least one tracking device to the status information received from the secondary system to determine the authenticity of the status information.

EMBODIMENT 19: The system as in Embodiments 11 through 18, further comprising an interface to allow the designated receiver to track a travel path of the monitored individual over a period of time.

EMBODIMENT 19: The system as in Embodiments 11 through 18, wherein the tracking device includes a real-time GPS tracker.

EMBODIMENT 20: A system for monitoring a monitored individual, comprising at least one tracking device for monitoring a location of the monitored individual; a verification device for confirming the monitored individual is a desired person to be monitored; a receiver for sending status information from the tracking device for the monitored individual to a monitoring system; a computing system for tracking the status information against a profile for the monitored individual to determine whether the monitored individual is in at least one of a defined allowed geographic region, a defined prohibited geographic region, and within a defined proximity relative to another monitored individual; and a transmitter for alerting a designated receiver if the monitored individual is at least one of not in the defined allowed geographic region, in the defined prohibited geographic region, and within a defined proximity relative to another monitored individual.

EMBODIMENT 21: A system for monitoring a monitored individual, comprising at least one tracking device for monitoring a location of the monitored individual; a verification device for confirming the monitored individual is a desired person to be monitored; a receiver for sending status information from the at least one tracking device for the monitored individual to a monitoring system; a computing system for tracking the status information against a profile for the monitored individual to determine whether the monitored individual is in compliance with a condition configured for the monitored individual; and a transmitter for alerting a designated receiver if the monitored individual is not in compliance with the condition.

EMBODIMENT 22: The system of as in Embodiment 22, wherein the condition is one of reporting to a probation or parole officer; participating in an intensive supervision program; remaining in a designated geographic area; maintaining regular employment; refraining from changing residences without permission; refraining from changing employment without permission; ceasing use of drugs or alcohol; refraining from entering a drinking establishment; refraining from associating with persons having criminal records; refraining from possessing firearms; and obeying other laws.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

That which is claimed is:

1. A method of monitoring an individual, comprising:
monitoring a monitored individual with at least one tracking device disposed proximate the monitored individual, wherein the tracking device is operable to determine a location of the monitored individual;
confirming the monitored individual is a desired person to be monitored using a verification device in electronic communication with the tracking device and in electronic communication with a monitoring system disposed apart from the monitored individual;
sending status information regarding the monitored individual from the tracking device to the monitoring system;
comparing the status information against a profile for the monitored individual to assess in real-time whether the monitored individual is in at least one of a defined permitted geographic region, a defined prohibited geographic region, or a defined proximity relative to another monitored individual;
generating attribute data for the monitored individual; and
sending an alert from the monitoring system to a designated receiver if the attribute data does not match the monitored individual or if the monitored individual is not in the defined permitted geographic region, is in the defined prohibited geographic region, or is within the defined proximity relative to another monitored individual.

2. The method of claim 1, wherein the verification device includes an identification system installed in the tracking device.

3. The method of claim 1, wherein the verification device includes a machine-learned identification system for generating the attribute data, the attribute data being refined with each check in by the monitored individual.

4. The method of claim 1, further comprising a biometric authenticator installed in the tracking device, the biometric authenticator selected from the group consisting of facial recognition, fingerprint recognition, thumb print recognition, eye vein recognition, finger vein recognition, hand geometry recognition, iris recognition, body odor recognition, palm print recognition, palm vein recognition, retinal scan recognition, skin reflection recognition, thermography recognition, keystroke dynamic recognition, signature recognition, speaker recognition, voice recognition, lip motion recognition, and combinations thereof.

5. The method of claim 1, wherein the verification device includes the tracking device that is secured to the monitored individual.

6. The method of claim 5, wherein the verification device is an ankle bracelet.

7. The method of claim 1, further comprising accessing status information for the monitored individual from an independent database on an additional monitoring system.

8. The method of claim 7, further comprising comparing the status information received from the tracking device to the database of the additional monitoring system to authenticate the status information.

9. The method of claim 1, further comprising storing the status information in a database.

10. The method of claim 9, wherein the designated receiver may track a travel path of the monitored individual over a period of time through an interface to the monitoring system.

11. A system for monitoring a monitored individual, comprising:
at least one tracking device, wherein the tracking device is operable to determine a location of the monitored individual;
a verification device used to determine that the monitored individual is a desired person to be monitored;
a receiver configured to receive status information for the monitored individual transmitted by the at least one tracking device;
a database for holding the received status information for the monitored individual;
at least one computing device to track the status information against a profile for the monitored individual to determine whether the monitored individual is in at least one of a defined allowed geographic region, a defined prohibited geographic region, and within a defined proximity relative to another monitored individual; and
a transmitter to alert a designated receiver if the monitored individual is at least one of not in the defined allowed geographic region, in the defined prohibited geographic region and within a defined proximity relative to another monitored individual, the computing device iteratively learning attributes of the monitored individual to issue a faster subsequent alert when status information has exceeded desired parameters.

12. The system of claim 11, wherein the verification device having at least one of an app-based identification system and a text-based identification system located on the tracking device.

13. The system of claim 11, wherein the verification device includes an app-based identification system and a biometric authenticator located on the tracking device.

14. The system of claim 13, wherein the biometric authenticator is selected from the group consisting of facial recognition, fingerprint recognition, thumb print recognition, eye vein recognition, finger vein recognition, hand geometry recognition, iris recognition, body odor recognition, palm print recognition, palm vein recognition, retinal scan recognition, skin reflection recognition, thermography recognition, keystroke dynamic recognition, signature recognition, speaker recognition, voice recognition, lip motion recognition, and combinations thereof.

15. The system of claim 11, wherein the verification device includes the tracking device that is secured to the monitored individual.

16. The system of claim 15, wherein the verification device is an ankle bracelet.

17. The system of claim 10, further comprising a procedure to access status information for the monitored individual from a secondary system.

18. The system of claim 17, wherein the procedure compares the status information received from the at least one tracking device to the status information received from the secondary system to determine the authenticity of the status information.

19. The system of claim 11, further comprising an interface to allow the designated receiver to track a travel path of the monitored individual.

20. The system of claim 11, wherein the tracking device includes a real-time GPS tracker.

21. A system for monitoring a monitored individual, comprising:
at least one tracking device for monitoring a location of the monitored individual;
a verification device for confirming the monitored individual is a desired person to be monitored;
a receiver for sending status information from the tracking device for the monitored individual to a monitoring system;
a computing system for tracking the status information against a profile for the monitored individual to determine whether the monitored individual is in at least one of a defined allowed geographic region, a defined prohibited geographic region, and within a defined proximity relative to another monitored individual; and
a transmitter for alerting a designated receiver if the monitored individual is at least one of not in the defined allowed geographic region, in the defined prohibited geographic region, and within a defined proximity relative to another monitored individual.

22. A system for monitoring a monitored individual, comprising:
at least one tracking device for monitoring a location of the monitored individual;
a verification device for confirming the monitored individual is a desired person to be monitored;
a receiver for sending status information from the at least one tracking device for the monitored individual to a monitoring system;
a computing system for tracking the status information against a profile for the monitored individual to determine whether the monitored individual is in compliance with a condition configured for the monitored individual; and
a transmitter for alerting a designated receiver if the monitored individual is not in compliance with the condition.

23. The system of claim 22, wherein the condition is one of reporting to a probation or parole officer; participating in an intensive supervision program; remaining in a designated geographic area; maintaining regular employment; refraining from changing residences without permission; refraining from changing employment without permission; ceasing use of drugs or alcohol; refraining from entering a drinking establishment; refraining from associating with persons having criminal records; refraining from possessing firearms; and obeying other laws.
